(19) United States
(12) Patent Application Publication
(10) Pub. No.: US 2024/0177514 A1
(43) Pub. Date: May 30, 2024

(54) LEARNING A FORM STRUCTURE

(71) Applicant: MICROSOFT TECHNOLOGY LICENSING, LLC, Redmond, WA (US)

(72) Inventors: Mattan SERRY, Herzliya (IL); Zvi FIGOV, Modin (IL)

(21) Appl. No.: 18/071,465

(22) Filed: Nov. 29, 2022

(51) Int. Cl. G06V 30/412; G06V 10/32; G06V 10/70; G06V 30/244; G06V 30/246

(52) U.S. Cl. CPC G06V 30/412; G06V 10/32; G06V 10/768; G06V 30/2455; G06V 30/246

(57) ABSTRACT

A system learns the structure of a form. The structure of the form can be learned from a single image (e.g., a photograph that includes the form) without user annotation. The form includes typewritten and handwritten text entries. The system groups text entries in the form based on lines detected in the form. The system then measures a distance and an angle between two text entry locations in the group of text entries. The group of text entries, the distances, and the angles can be captured in a bipartite graph. The bipartite graph represents possible pairing solutions where a typewritten text entry is paired with a handwritten text entry. The system identifies an optimal pairing solution, from the possible pairing solutions, using the distances and angles. The optimal pairing solution is identified by minimizing the standard deviation of the distances and/or by minimizing the circular standard deviation of the angles.

### BACKGROUND

Recently, computer vision has been developed to implement form recognition. There are various types of forms users fill out for different purposes. To name a few, doctor's offices often request that users fill out medical forms, schools often request that users fill out education forms, production studios have users fill out clapperboard forms when capturing scenes for a movie, financial institutions often request that users fill out financial forms, etc. Different forms, from a variety of contexts, typically include two types of entries. A first type of entry is a typewritten text entry. A second type of entry is a handwritten text entry.

A typewritten, or printed, text entry typically serves as a prompt for a user to enter a corresponding handwritten text entry. Therefore, a handwritten text entry typically provides an answer to the prompt. Consequently, the general intent of various forms is to pair a typewritten text entry with a handwritten text entry.

### SUMMARY

The disclosed techniques implement a system that learns the structure of a form. The form includes different types of entries, such as typewritten text entries and handwritten text entries. As mentioned above, typewritten text entries on a form typically prompt a user to enter handwritten text entries (i.e., field/input pairs, key/value pairs). In one example, typewritten text entries prompt a user to enter a “NAME”, a “DATE”, a “TAKE”, and so forth. Accordingly, the handwritten text entries include answers to the typewritten text entries, such as “Joe D.”, “Oct. 17, 2022”, “42”, and so forth.

As described herein, the structure of a form can be learned from a single image (e.g., a scanned document that captures the form, a photograph that includes the form) without user annotation. Once the structure of the form is learned, the system is able to accurately extract the pairings between typewritten text entries and handwritten text entries from other images that include the same form. In one example, accurate extraction of the pairings ensures that the information extracted in the form can be stored correctly in a database. In the context of clapperboard forms, the learned structure is used to accurately extract a handwritten name for a director of a movie and store the handwritten name in a director column of the database. Similarly, the learned structure is used to accurately extract a handwritten name for a cameraperson for a scene and store the handwritten name in a cameraperson column of the database.

The system includes an optical character recognition module and a line detection module. Provided an image that includes a form, the optical character recognition module distinguishes between different types of text entries included in the form. For instance, the optical character recognition module is configured to distinguish between typewritten text entries and handwritten text entries. The optical character recognition module further identifies locations of the typewritten text entries and the handwritten text entries on the form. As described herein, a location can be represented by a bounding box that contains the typewritten text or the handwritten text. The line detection module detects lines that separate the text entries in the form. The detected lines serve as constraints when determining the structure of the form for the purposes of accurately extracting pairings between the typewritten text entries and the handwritten text entries.

The system further includes a graph generation module. Provided the locations of the text entries, the graph generation module identifies groups of text entries using the detected lines. A group of text entries refers to text entries that have locations that are not separated by a detected line. Consequently, a first location of a first text entry and a second location of a second text entry are grouped together if an imaginary straight line from any part of the first location to any part of the second location does not intersect a detected line.

As described above, various types of completed forms (i.e., forms that have been filled out by a user) include a number N of paired typewritten text entries and handwritten text entries. Consequently, a group of text entries identified by the graph generation module typically includes a set of typewritten text entries and a set of handwritten text entries. A “set” includes at least two text entries (e.g., two, three, four, five). Moreover, a number of typewritten text entries in the set of typewritten text entries for the group is typically the same as the number of handwritten text entries in the set of handwritten text entries for the group.

The graph generation module creates a bipartite graph for the set of typewritten text entries and the set of handwritten text entries in a group. A bipartite graph includes first vertices on one side (e.g., the left side) and second vertices on the other side (e.g., the right side). The first vertices correspond to respective typewritten text entries in the set of typewritten text entries and the second vertices correspond to respective handwritten text entries in the set of handwritten text entries. Furthermore, the bipartite graph includes an edge that connects each first vertex with each second vertex. Consequently, each first vertex in the bipartite graph is connected to all the second vertices and each second vertex in the bipartite graph is connected to all the first vertices.

An edge includes a distance property. The distance property represents a distance between a location of the typewritten text entry corresponding to the first vertex connected to the edge and a location of the handwritten text entry corresponding to the second vertex connected to the edge. Accordingly, the graph generation module is configured to measure, on the image that includes the form, the distance between the location of the typewritten text entry corresponding to the first vertex connected to the edge and the location of the handwritten text entry corresponding to the second vertex connected to the edge. In various examples, the distance measurement is normalized, e.g., to a value between and including zero and one [0:1], because distances can change based on the width of the image, the height of the image, and/or the resolution of the image.

Furthermore, an edge includes an angle property. The angle property represents an angle between the location of the typewritten text entry corresponding to the first vertex connected to the edge and the location of the handwritten text entry corresponding to the second vertex connected to the edge. Accordingly, the graph generation module is configured to measure the angle between the location of the typewritten text entry corresponding to the first vertex connected to the edge and the location of the handwritten text entry corresponding to the second vertex connected to the edge.

In various examples, the angle is measured using a standard definition where: an element (e.g., a handwritten text entry) that is directly to the right of a base element (e.g., a typewritten text entry) has an angle of zero degrees (or alternatively three hundred and sixty degrees), an element that is directly above the base element has an angle of ninety degrees, an element that is directly to the left of the base element has an angle of one hundred and eighty degrees, and an element that is directly below the base element has an angle of two hundred and seventy degrees.

Considering the distance property and the angle property, each edge in the bipartite graph can be treated as a vector from the location of the typewritten text entry to the location of the handwritten text entry. The bipartite graph is generated to represent all the possible pairing solutions for the first vertices and the second vertices. In a single pairing solution, an individual first vertex cannot be connected to more than one second vertex, and vice versa. This means that the intent of the structure of the form is to have a one-to-one correspondence between a typewritten text entry and a handwritten text entry.

The graph generation module passes the bipartite graph for a group of text entries to a pairing optimization module. The pairing optimization module applies a pairing algorithm to the bipartite graph. The pairing algorithm uses the distance properties and the angle properties associated with the edges between the first vertices and the second vertices to identify an optimal pairing solution amongst the multiple possible pairing solutions. To do this, the pairing algorithm employs assumptions. More specifically, the pairing algorithm assumes that a typewritten text entry and its paired handwritten text entry (i.e., input, value) are generally close to one another (e.g., the shorter the distance between the two entry locations the stronger the pairing signal). Furthermore, for left-to-right written languages (e.g. English, Spanish, Italian), the pairing algorithm assumes that the typewritten text entry is to the left of, and/or above, its paired handwritten text entry. The pairing algorithm considers the possible pairing solutions and, based on the assumptions, identifies the optimal pairing solution by minimizing the standard deviation of the measured distances between paired text entries, by minimizing the circular standard deviation of the measured angles for the paired text entries, by minimizing the sum of the measured distances between the paired text entries, and/or by minimizing a sum of unlikelihood scores for the paired text entries, which are calculated based on the measured angles.

The optimal pairing solution provides the basis to learn, or understand, the structure of the form in the absence of lines that clearly define the pairings. The learned structure of the form associates a location of a handwritten text entry with a location of typewritten text entry. The system is able to use the learned structure of the form to accurately extract the pairings from other images that contain the form, and correctly store or otherwise process the recognized text according to the extracted pairings. Consequently, the system described herein improves the automated processing and indexing of forms where handwritten text entries are paired with typewritten text entries. Moreover, by using the detected lines as constraints when creating the groups, the number of possible options to consider is reduced and the amount of resources needed to learn the structure of the form is reduced.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items.

FIG. 1 illustrates an example environment in which a system learns the structure of a form with typewritten text entries and handwritten text entries.

FIG. 2A illustrates an example form which is analyzed in order to distinguish between typewritten text entries and handwritten text entries.

FIG. 2B illustrates the example form of FIG. 2A, which is analyzed in order to locate the typewritten text entries and the handwritten text entries on the form.

FIG. 3A illustrates an example bipartite graph generated for a group of text entries identified in the example form of FIGS. 2A and 2B.

FIG. 3B illustrates another example bipartite graph generated for another group of text entries identified in the example form of FIGS. 2A and 2B.

FIG. 4A illustrates an example definition useable to measure an angle.

FIG. 4B illustrates a plot that shows unlikelihood scores that result from measured angles, based on assumption(s).

FIG. 5 illustrates an example edge, which is treated as a vector with a distance property and an angle property.

FIG. 6 is an example flow diagram showing aspects of a routine implemented to learn a structure of a form.

FIG. 7 is a computer architecture diagram showing an illustrative computer hardware and software architecture for a computing system capable of implementing aspects of the techniques and technologies presented herein.

### DETAILED DESCRIPTION

The techniques described herein implement a system that learns the structure of a form. The structure of the form can be learned from a single image (e.g., a scanned document that captures the form, a photograph that includes the form) without user annotation. The form includes typewritten text entries and handwritten text entries. The system groups text entries in the form based on constraints established from lines detected in the form. The system then measures a distance and an angle between two text entry locations in the group of text entries. The group of text entries, the distances, and the angles can be captured in a bipartite graph. The bipartite graph represents all the possible pairing solutions where a typewritten text entry in the form is paired with a handwritten text entry. The system identifies an optimal pairing solution, from the possible pairing solutions, using the distances and angles. The optimal pairing solution is identified by minimizing the standard deviation of the measured distances between paired text entries, by minimizing the circular standard deviation of the measured angles for the paired text entries, by minimizing the sum of the measured distances between the paired text entries, and/or by minimizing a sum of unlikelihood scores for the paired text entries, which are calculated based on the measured angles.

Form recognition attempts to extract the pairings between typewritten text entries and handwritten text entries. However, it is challenging to extract the pairings if the structure of the form does not include lines that clearly define the pairings between the typewritten text entries and the handwritten text entries. To illustrate, a clapperboard form may include a first typewritten text entry asking for a name of a “director” and a second typewritten text entry asking for a name of a “cameraperson”. In the absence of a line that separates the first typewritten text entry and the second typewritten text entry, conventional form recognition techniques may incorrectly associate a handwritten name of the director with the second typewritten text entry, which is asking for the name of a “cameraperson”. Similarly, the conventional form recognition techniques may incorrectly associate a handwritten name of the cameraperson with the first typewritten text entry, which is asking for the name of a “director”.

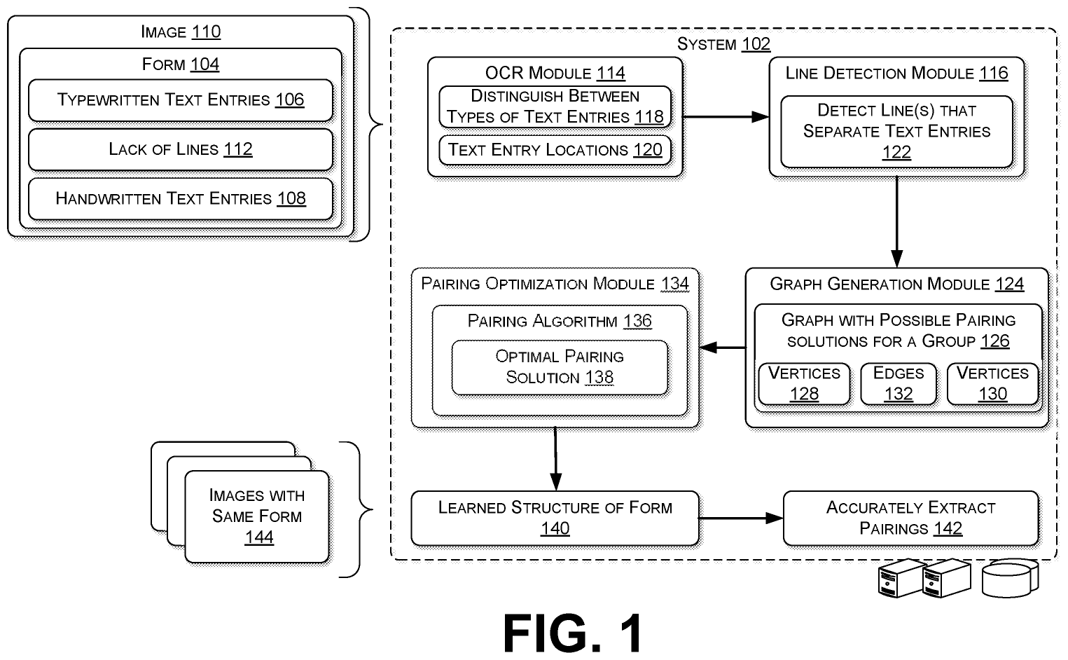

The optimal pairing solution identified herein provides a basis to learn, or understand, the structure of the form in the absence of lines that clearly define the pairings. The system is able to use the learned structure of the form to accurately extract the pairings from other images that contain the form, and correctly store or otherwise process the recognized text according to the extracted pairings. Consequently, the system described herein improves the automated processing and indexing of forms where handwritten text entries are filled in to be paired with typewritten text entries. Various examples, scenarios, and aspects that enable the techniques described herein are described below with respect to FIGS. 1-7.

FIG. 1 illustrates an example environment 100 in which a system 102 learns the structure of a form 104 that includes typewritten text entries 106 and handwritten text entries 108. In various examples, the form 104 is included in an image 110 (e.g., a scanned document, a photograph). The system 102 is tasked with learning the structure of the form 104 in scenarios where the form 104 lacks a sufficient amount of lines 112 that clearly define pairings for the typewritten text entries 106 and the handwritten text entries 108. In various examples, an image 110 is selected from a number of images in which the form has been filled out by different users, and the image 110 is used to learn the structure. The selection is made based on the image 110 including well-placed handwritten text entries 108 in the form 104, as the locations of the typewritten text entries are fixed. Consequently, the selected image 110 is a good representation of where various users will typically write their answers (e.g., inputs, values) to the typewritten text entries 106 included in the form 104.

The system 102 includes an optical character recognition module 114 and a line detection module 116. Provided the image 110, the optical character recognition module 114 distinguishes between types of text entries 118 in the form 104. Specifically, the optical character recognition module 114 analyzes the image and identifies a text entry as a typewritten text entry 106 or a handwritten text entry 108.

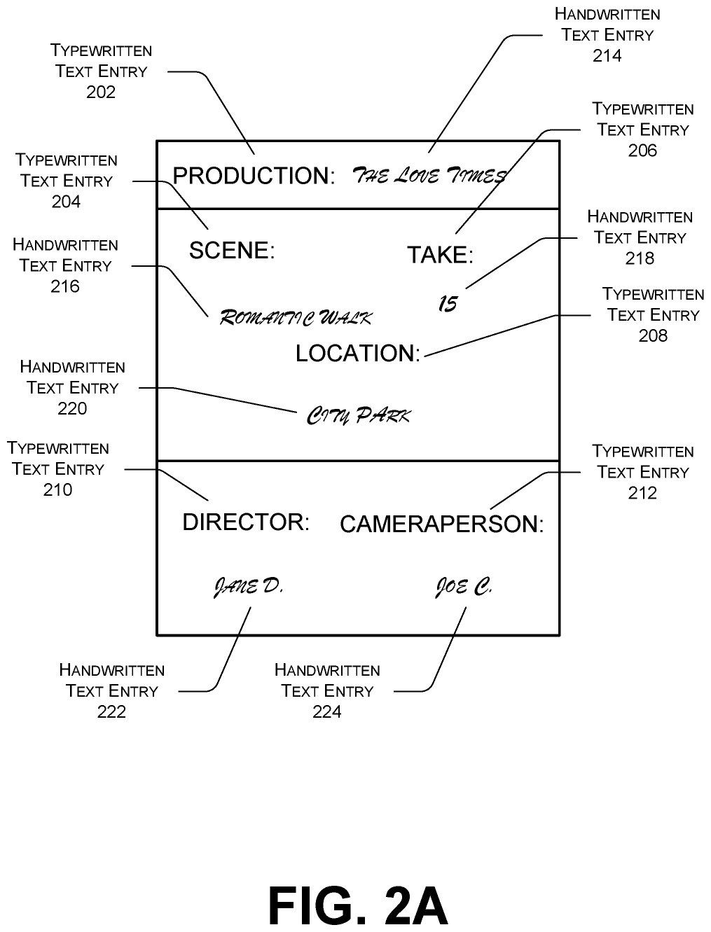

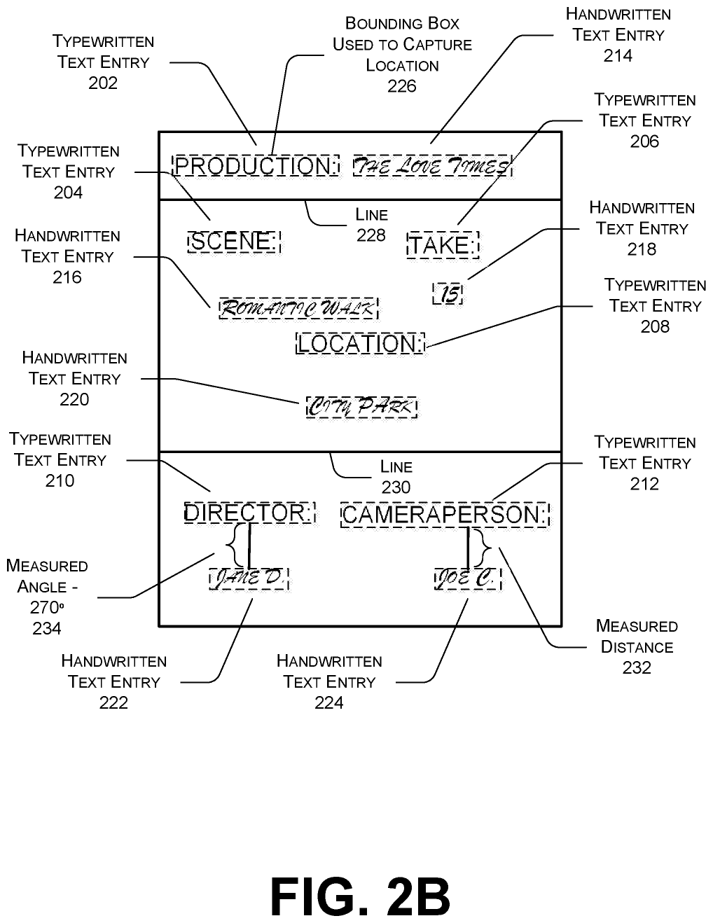

FIG. 2A illustrates an example form 200, which has already been completed (e.g., filled out) by a user. As illustrated, the form 200 includes various text entries. With respect to FIG. 2A, the optical character recognition module 114 identifies: “PRODUCTION” as a typewritten text entry 202, “SCENE” as a typewritten text entry 204, “TAKE” as a typewritten text entry 206, “LOCATION” as a typewritten text entry 208, “DIRECTOR” as a typewritten text entry 210, and “CAMERAPERSON” as a typewritten text entry 212. Similarly, the optical character recognition module 114 identifies: “The Love Times” as a handwritten text entry 214, “Romantic Walk” as a handwritten text entry 216, “15” as a handwritten text entry 218, “City Park” as a handwritten text entry 220, “Jane D.” as a handwritten text entry 222, and “Joe C.” as a handwritten text entry 224.

Turning back to FIG. 1, the optical character recognition module 114 further identifies locations 120 of the typewritten text entries 106 and the handwritten text entries 108 on the form 104. A location 120 can be represented by a bounding box that contains the text in a text entry. FIG. 2B illustrates the example form 200 of FIG. 2A, in which the locations of the typewritten text entries 202, 204, 206, 208, 210, 212 and the locations of the handwritten text entries 214, 216, 218, 220, 222, 224 are illustrated as bounding boxes, represented by the dashed lines that surround the text (e.g., an example bounding box 226 is called out for the “PRODUCTION” typewritten text entry 202).

Turning back to FIG. 1, the line detection module 116 detects lines 122, in the form 104, that separate text entries. The detected lines serve as constraints when determining the structure of the form 104 for the purposes of accurately extracting pairings between the typewritten text entries 106 and the handwritten text entries 108. Moreover, the outer edges of the image 110 and/or the form 104 also serve as constraints. Switching the attention back to FIG. 2B, the line detection module 116 detects a first line 228 that separates text entries 202, 214 from text entries 204, 206, 216, 218, 208, 220. Moreover, the line detection module 116 detects a second line 230 that separates text entries 204, 206, 216, 218, 208, 220 from text entries 210, 212, 222, 224.

A graph generation module 124 of the system 102 in FIG. 1 groups the text entries using the detected lines 122. That is, the graph generation module 124 determines the text entry locations 120 that are not separated by a detected line 122. Stated alternatively, a first text entry at a first location 120 is grouped with a second text entry at a second location 120 if an imaginary straight line drawn from the first location to the second location does not intersect a detected line 122.

As described above, various types of completed forms (i.e., forms that have been filled out by a user) from different contexts and/or industries include a number N of paired typewritten text entries and handwritten text entries. Consequently, a group of text entries identified by the graph generation module 124 typically includes a set of typewritten text entries and a set of handwritten text entries. A “set” includes at least two text entries (e.g., two, three, four, five). Moreover, a number of typewritten text entries in the set of typewritten text entries for the group is typically the same as the number of handwritten text entries in the set of handwritten text entries for the group. However, the number of typewritten text entries in the set of typewritten text entries for the group can be greater than or less than the number of handwritten text entries in the set of handwritten text entries for the group.

The graph generation module 124 creates a bipartite graph 126 for the set of typewritten text entries and the set of handwritten text entries in a group. Looking back at FIGS. 2A and 2B, a first group of text entries includes text entries 204, 206, 216, 218, 208, 220 and a second group of text entries includes text entries 210, 212, 222, 224. Text entries 202, 214 are not included in a group in the context of this disclosure because there is only one typewritten text entry 202 and one handwritten text entry 214 inside the area created by the detected line 228 and the edges of the image 110. Consequently, the pairing of the typewritten “PRODUCTION” 202 with handwritten “The Love Times” 214 is definite due to the detected line 228 and the edges of the image 110 and/or the form 104.

Looking back to FIG. 1, the bipartite graph 126 represents all the possible pairing solutions. Each pairing solution pairs a typewritten text entry 106 with a handwritten text entry 108. Accordingly, the bipartite graph 126 includes first vertices 128 on one side (e.g., the left side) and second vertices 130 on the other side (e.g., the right side). The first vertices 128 correspond to the typewritten text entries in the set of typewritten text entries of the group and the second vertices 130 correspond to the handwritten text entries in the set of handwritten text entries of the group. Furthermore, the bipartite graph 126 includes edges 132 that connect the first vertices 128 and the second vertices 130. More specifically, the bipartite graph 126 includes an edge 132 between each first vertex 128 and each second vertex 130, such that each first vertex 128 in the bipartite graph 126 is connected to all the second vertices 130 and each second vertex 130 in the bipartite graph 126 is connected to all the first vertices 128. In a single pairing solution, an individual first vertex 128 cannot be connected to more than one second vertex 130, and vice versa. This means that the intent of the structure of the form 104 is to have a one-to-one correspondence between a typewritten text entry 106 and a handwritten text entry 108.

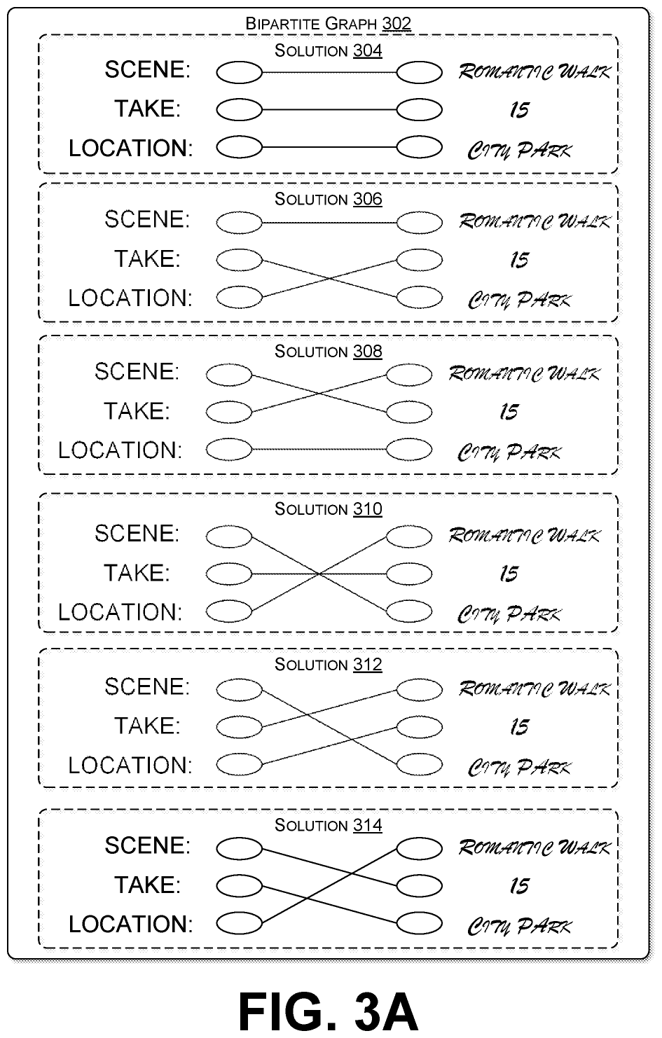

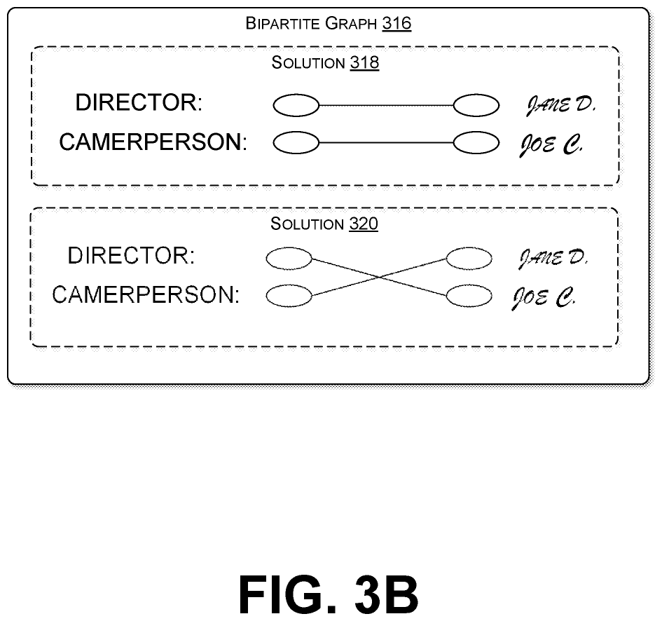

FIG. 3A illustrates an example bipartite graph 300 for the group of text entries that includes text entries 204, 206, 216, 218, 208, 220 from FIGS. 2A and 2B. The bipartite graph 302 includes possible pairing solutions 304, 306, 308, 310, 312, 314. Each pairing solution includes first vertices 128 (e.g., represented by the ovals) on the left for the typewritten text entries “SCENE” 204, “TAKE” 206, and “LOCATION” 208. Moreover, each pairing solution includes second vertices 130 on the right for the handwritten text entries “Romantic Walk” 216, “15” 218, and “City Park” 220. While the vertices are consistent across the possible pairing solutions 304, 306, 308, 310, 312, 314, the edges 132 that connect the first vertices 128 representing the typewritten text entries to the second vertices 130 representing the handwritten text entries vary from one pairing solution to the next.

FIG. 3B illustrates an example bipartite graph 316 for the group of text entries that includes text entries 210, 212, 222, 224 from FIGS. 2A and 2B. The bipartite graph 316 includes possible pairing solutions 318 and 320. Each pairing solution includes first vertices 128 on the left for the typewritten text entries “DIRECTOR” 210 and “CAMERAPERSON” 212. Moreover, each pairing solution includes second vertices 130 on the right for the handwritten text entries “Jane D.” 222 and “Joe C.” 224. Similar to FIG. 3A, while the vertices are consistent across the possible pairing solutions 318 and 320, the edges 132 that connect the first vertices 128 representing the typewritten text entries to the second vertices 130 representing the handwritten text entries vary from one pairing solution to the next.

An edge 132 includes a distance property. The distance property represents a distance between a location 120 of a typewritten text entry 106 corresponding to a first vertex 128 connected to the edge 132 and a location 120 of a handwritten text entry 108 corresponding to a second vertex 130 connected to the same edge 132. Accordingly, the graph generation module 124 is configured to measure, on the image 110, the distance between the location 120 of the typewritten text entry 106 and the location 120 of the handwritten text entry 108.

Looking back, FIG. 2B illustrates an example measured distance 232 between the “CAMERAPERSON” typewritten text entry 212 and the “Joe C.” handwritten text entry 224. In various examples, the distance is measured as the shortest path between the boundaries of two non-overlapping bounding boxes. For example, if a bounding box is denoted by an array of 4 pixel coordinates, {Left, Top, Right,Bottom}, two non-overlapping bounding boxes are denoted as BB_1={Left_1,Top_1,Right_1,Bottom_1} and BB_2={Left_2,Top_2,Right_2,Bottom_2}. In a more specific example, if a first bounding box partially overlaps a second bounding box on a vertical axis (e.g., Bottom_1≤ Bottom_2≤ Top_1), the shortest path is a horizontal line from the first bounding box to the second bounding box. In another more specific example, if a first bounding box completely overlaps a second bounding box along a horizontal axis, the shortest path is a vertical line from the first bounding box to the second bounding box. In yet another more specific example, if there is no overlap along either a vertical axis or a horizontal axis, the shortest path, the distance can be calculated in the Euclidean sense as follows in equation (1):

\sqrt{(Left₂−Right₁)²+(Top₂−Bottom₁)²} equation (1)

In various examples, the distance measurement is normalized, e.g., to a value between and including zero and one [0:1], because distances can change based on the width of the image, the height of the image, and/or the resolution of the image.

Furthermore, an edge 132 includes an angle property. The angle property represents an angle between a location 120 of a typewritten text entry 106 corresponding to the first vertex 128 connected to the edge 132 and a location 120 of the handwritten text entry 108 corresponding to the second vertex 130 connected to the edge 132. Accordingly, the graph generation module 124 is configured to measure the angle between the location 120 of the typewritten text entry 106 and the location 120 of the handwritten text entry 108.

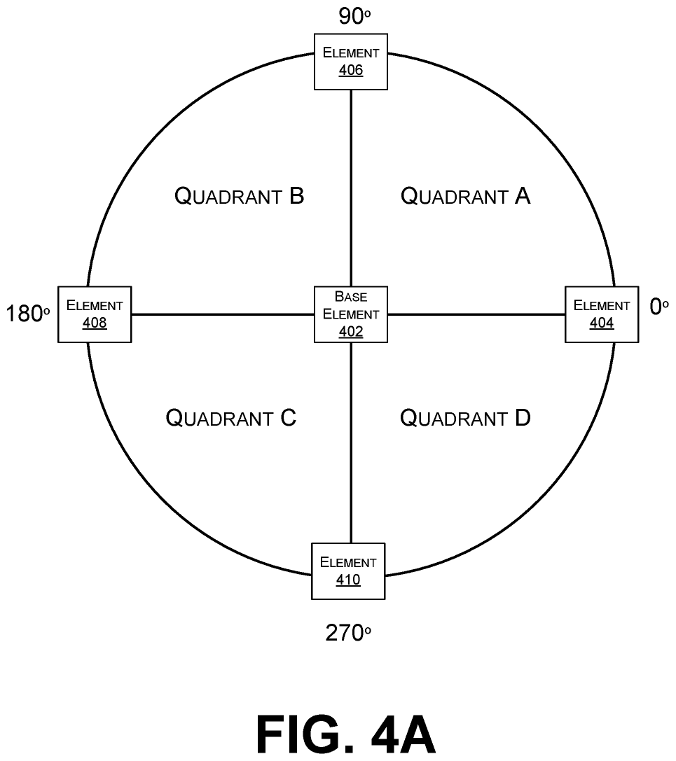

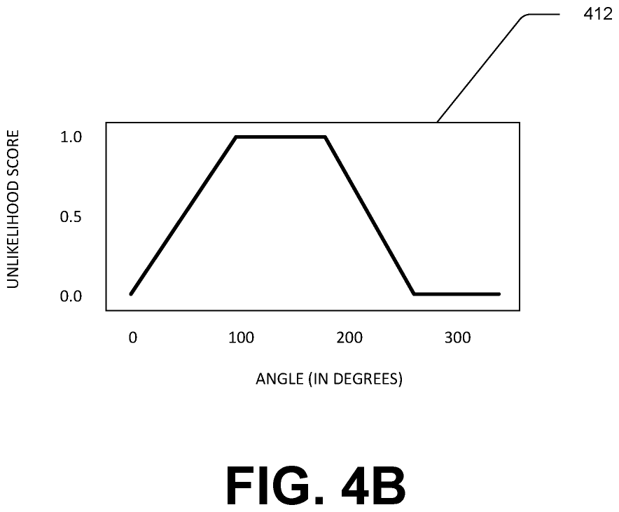

FIG. 4A illustrates an example definition useable to measure an angle. In various examples, the angle is measured using a format where a base element 402 (e.g., a typewritten text entry) is in the middle. An element 404 (e.g., a handwritten text entry) that is directly to the right of the base element 402 has an angle of zero degrees (or alternatively three hundred and sixty degrees). An element 406 (e.g., a handwritten text entry) that is directly above the base element 402 has an angle of ninety degrees. An element 408 (e.g., a handwritten text entry) that is directly to the left of the base element 404 has an angle of one hundred and eighty degrees. And an element 410 (e.g., a handwritten text entry) that is directly below the base element 404 has an angle of two hundred and seventy degrees. Turning back to FIG. 2B, an example of an angle measurement 234 between the “DIRECTOR” typewritten text entry 210 and the “Jane D.” handwritten text entry 222 is two hundred and seventy degrees.

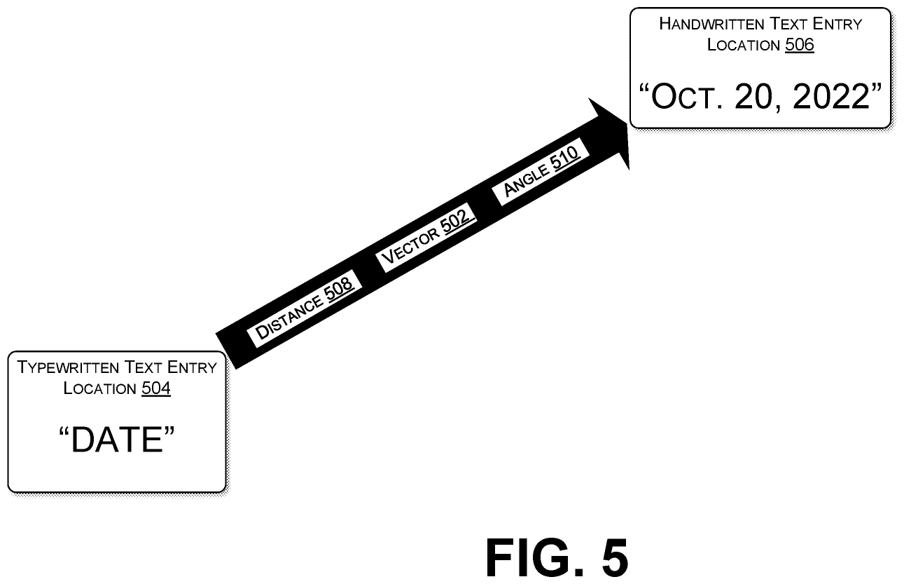

Considering the distance property and the angle property, each edge 132 in the bipartite graph 126 can be treated as a vector 502 from a location 504 of a typewritten text entry (e.g., “DATE”) to a 506 location of a handwritten text entry (e.g., “Oct. 20, 2022”), as shown in FIG. 5. The vector 502 includes the measured distance 508 and the measured angle 510.

Turning back to FIG. 1, the graph generation module 124 passes the bipartite graph 126 for a group of text entries to a pairing optimization module 134. The pairing optimization module 134 applies a pairing algorithm 136 to the bipartite graph 126. The pairing algorithm 136 uses the distance properties and the angle properties associated with the edges 132 between the first vertices 128 and the second vertices 130 to identify an optimal pairing solution 138, from the possible pairing solutions.

The pairing algorithm 136 uses assumptions to identify the optimal pairing solution 138. Specifically, the pairing algorithm 136 assumes that a typewritten text entry and its paired handwritten text entry (i.e., input, value) are generally close to one another (e.g., the shorter the distance between two locations the stronger the pairing signal). Furthermore, for left-to-right written languages, the pairing algorithm 136 assumes that the typewritten text entry is to the left of, and/or above, the paired handwritten text entry. Consequently, the pairing algorithm 136 considers the possible pairing solutions and, based on the assumptions, identifies the optimal pairing solution 138 by minimizing the standard deviation of the measured distances between paired text entries, by minimizing the circular standard deviation of the measured angles for the paired text entries, by minimizing the sum of the measured distances between the paired text entries, and/or by minimizing a sum of unlikelihood scores for the paired text entries, which are calculated based on the measured angles.

For example, the pairing algorithm 136 identifies the pairing solution 304 as the optimal pairing solution 138 for the group of text entries that includes text entries 204, 206, 216, 218, 208, 220 from FIGS. 2A and 2B. If only distance is used (and not angle), the “Romantic Walk” handwritten text entry 216 would be incorrectly paired with the “LOCATION” typewritten text entry 208. In another example, the pairing algorithm 136 identifies the pairing solution 318 as the optimal pairing solution 138 for the group of text entries that includes text entries 210, 212, 222, 224 from FIGS. 2A and 2B.

Described below is a specific example of a pairing algorithm 136 that identifies the optimal pairing solution 138 from the possible pairing solutions based on defined metric functions that utilize the distance properties and the angle properties of the edges 132. As mentioned above, because distances can change based on varying image dimensions, the pairing algorithm 136 defines a normalized distance, or normalized radius [symbol] , between and including zero and one [0:1] for each edge e, as follows in equation (2):

$$= \frac{{e}_{R}}{\sqrt{{Height}_{image}^{2} + {Width}_{image}^{2}}} \qquad equation ( 2 )$$

In equation (2), e_{R} is the measured distance, or radius, of the edge e.

In contrast to distances, angles are not dependent on image dimensions. Using the assumption that a handwritten text entry is generally to the right and/or below the typewritten text entry with which it should be paired, the pairing algorithm 136 can use an unlikelihood piecewise-linear scoring function for angles, as follows in equation (3):

$$Unlikelihood ( θ ) = \{ \begin{matrix}\frac{θ}{90 °} & if 0 ° \leq θ \leq 90 ° \\ 1 & if 90 ° \leq θ \leq 180 ° \\ \frac{270 ° - θ}{90 °} & if 180 ° \leq θ \leq 270 ° \\ 0 & if 270 ° \leq θ \leq 360 °\end{matrix} \qquad equation ( 3 )$$

Turning back to FIG. 4A, equation (3) satisfies the assumption that an associated handwritten text entry is generally below (i.e., between one hundred and eighty degrees and three hundred and sixty (or zero) degrees as represented by Quadrant C or Quadrant D) or to the right (i.e., between two hundred and seventy degrees and ninety degrees as represented by Quadrant A or Quadrant D) of the typewritten text entry with which it should be paired. So if the handwritten text entry is to the right and above the typewritten text entry (Quadrant A in FIG. 4A), equation (3) indicates a score value calculated by

$$\frac{θ}{90 °} .$$

If the handwritten text entry is to the left and/or above from the typewritten text entry (Quadrant B in FIG. 4A), equation (3) indicates a score value of one. If the handwritten text entry is to the left and/or below the typewritten text entry (Quadrant C in FIG. 4A), equation (3) indicates a score value calculated by

$$\frac{27 {0}^{°} - θ}{90 °} .$$

And it the handwritten text entry is to the right and/or below the typewritten text entry (Quadrant D in FIG. 4), equation (3) indicates a score value of zero. FIG. 4B illustrates a graph 412 that plots the unlikelihood score, represented by the y-axis, based on the angle represented by the x-axis.

The unlikelihood piecewise-linear scoring function for angles can change based on different assumptions, such as different writing directions. As an example, for right-to-left written languages (e.g., Arabic, Hebrew), the unlikelihood piecewise-linear scoring function for angles is as follows in equation (4):

$$Unlikelihood ( θ ) = \{ \begin{matrix}1 & if 0 ° \leq θ \leq 90 ° \\ \frac{θ}{90 °} & if 90 ° \leq θ \leq 180 ° \\ 0 & if 180 ° \leq θ \leq 270 ° \\ \frac{270 ° - θ}{90 °} & if 270 ° \leq θ \leq 360 °\end{matrix} \qquad equation ( 4 )$$

Now that the pairing algorithm 136 has normalized the distances and scored the angles based on assumptions, the pairing algorithm 136 can determine an optimal solution, Sₒₚₜᵢₘₐₗ, for one group or multiple groups G, as follows in equation (5):

$${S}_{optimal} = {argmin}_{S} [ α * σ ( {S}_{\tilde{R}} ) + β * ϑ ( {S}_{θ} ) + {\sum }_{e ∈ S} ( γ * {e}_{\tilde{R}} + δ * Unlikelihood ( {e}_{θ} ) ) ] \qquad equation ( 5 )$$

In equation (5), S is a possible solution that defines the edges e in groups G, G_{θ} represents the angles θ of the edges e in a graph G, G_{\tilde{G}} represents the normalized distances (radiuses) in the graph G, and {α,β,γ,δ} are non-negative weight parameters. As shown, equation (5) uses equation (2) and equation (3) (or alternatively, equation (4)). Consequently, equation (5) minimizes the following properties:
The standard deviation of the normalized distances (radiuses) for the paired text entries.
The circular standard deviation of the angles for the paired text entries.
The sum of normalized distances between paired text entries.
The sum of unlikelihood scores for the paired text entries.

Turning back to FIG. 1, the optimal pairing solution 138 is used as a basis to learn, or understand, the structure of the form 140. The learned structure of the form 140 associates a location of a handwritten text entry with a location of typewritten text entry. The system 102 is able to use the learned structure of the form 140 to accurately extract the pairings 142 from other images 144 that contain the same form 104, and correctly store or otherwise process the recognized text according to the extracted pairings. Consequently, the system 102 improves the automated processing and indexing of forms where handwritten text entries are filled in to be paired with typewritten text entries. Moreover, by using the detected lines as constraints when creating the groups, the number of possible options to consider is reduced and the amount of resources needed to learn the structure of the form is reduced.

The number of illustrated modules in FIG. 1 is just an example, and the number can vary (e.g., be higher or lower). That is, functionality described herein in association with the illustrated modules can be performed by a fewer number of modules or a larger number of modules on one device or spread across multiple devices. Further, the system 102 can include one or more computing devices (e.g., servers) that operate in a cluster or other grouped configuration to share resources, balance load, increase performance, provide fail-over support or redundancy, or for other purposes.

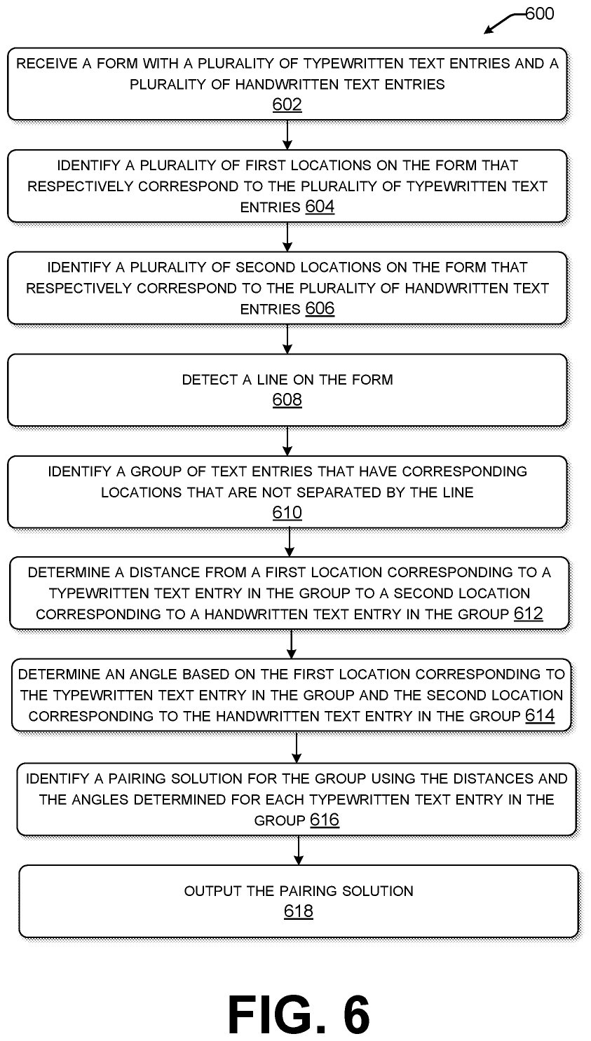

Turning now to FIG. 6, aspects of a method 600 implemented to learn a structure of a form are shown and described. The method 600 beings at operation 602 where a form with a plurality of typewritten text entries and a plurality of handwritten text entries is received. At operation 604, a plurality of first locations that respectively correspond to the plurality of typewritten text entries are identified on the form. At operation 606, a plurality of second locations that respectively correspond to the plurality of handwritten text entries are identified on the form.

At operation 608, a line is detected on the form. At operation 610, a group of text entries that have corresponding locations that are not separated by the line is identified. At operation 612, a distance from a first location corresponding to a typewritten text entry in the group to a second location corresponding to a handwritten text entry in the group is determined. At operation 614, an angle based on the first location corresponding to the typewritten text entry in the group and the second location corresponding to the handwritten text entry in the group is determined.

At operation 616, a pairing solution is identified using the distances and the angles determined for each typewritten text entry in the group. At operation 618, the pairing solution is output. For example, the pairing solution is the optimal one usable to learn a structure of the form.

For ease of understanding, the process discussed in this disclosure is delineated as separate operations represented as independent blocks. However, these separately delineated operations should not be construed as necessarily order dependent on their performance. The order in which the process is described is not intended to be construed as a limitation, and any number of the described process blocks may be combined in any order to implement the process or an alternate process. Moreover, it is also possible that one or more of the provided operations is modified or omitted.

The particular implementation of the technologies disclosed herein is a matter of choice dependent on the performance and other requirements of a computing device. Accordingly, the logical operations described herein may be referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entirety. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system.

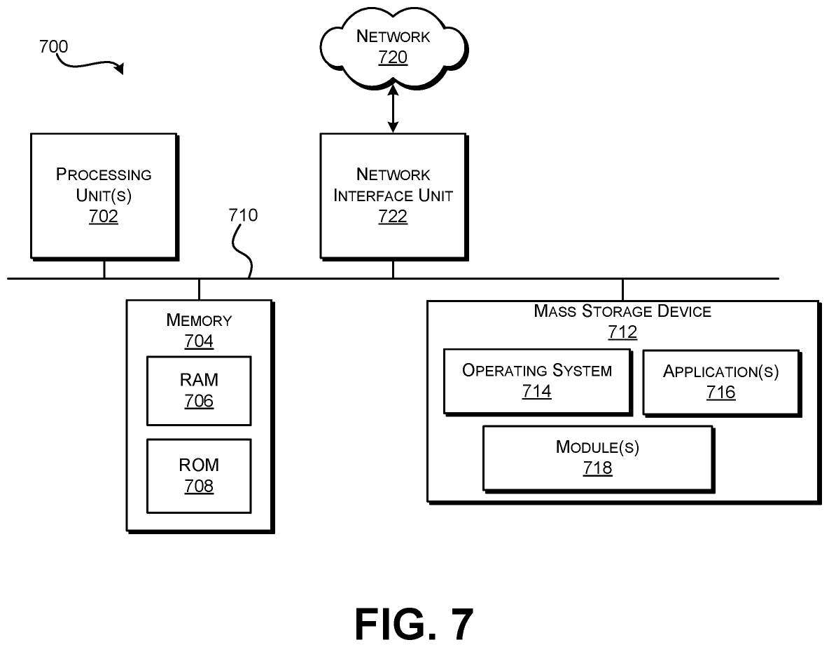

FIG. 7 shows additional details of an example computer architecture 700 for a device, such as a computer or a server capable of executing computer instructions (e.g., a module described herein). The computer architecture 700 illustrated in FIG. 7 includes processing system including processing unit(s) 702, a system memory 704, including a random-access memory 706 (RAM) and a read-only memory (ROM) 708, and a system bus 710 that couples the memory 704 to the processing unit(s) 702. In various examples, the processing units 702 of the processing system are distributed. Stated another way, one processing unit 702 of the processing system may be located in a first location (e.g., a rack within a datacenter) while another processing unit 702 of the processing system is located in a second location separate from the first location.

Processing unit(s), such as processing unit(s) 702, can represent, for example, a CPU-type processing unit, a GPU-type processing unit, a field-programmable gate array (FPGA), another class of digital signal processor (DSP), or other hardware logic components that may, in some instances, be driven by a CPU. For example, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), and the like.

A basic input/output system containing the basic routines that help to transfer information between elements within the computer architecture 700, such as during startup, is stored in the ROM 708. The computer architecture 700 further includes a mass storage device 712 for storing an operating system 714, application(s) 716, modules 718, and other data described herein.

The mass storage device 712 is connected to processing unit(s) 702 through a mass storage controller connected to the bus 710. The mass storage device 712 and its associated computer-readable media provide non-volatile storage for the computer architecture 700. Although the description of computer-readable media contained herein refers to a mass storage device, it should be appreciated by those skilled in the art that computer-readable media can be any available computer-readable storage media or communication media that can be accessed by the computer architecture 700.

Computer-readable media includes computer-readable storage media and/or communication media. Computer-readable storage media includes one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including RAM, static RAM (SRAM), dynamic RAM (DRAM), phase change memory (PCM), ROM, erasable programmable ROM (EPROM), electrically EPROM (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 700 may operate in a networked environment using logical connections to remote computers through the network 720. The computer architecture 700 may connect to the network 720 through a network interface unit 722 connected to the bus 710.

It should be appreciated that the software components described herein may, when loaded into the processing unit(s) 702 and executed, transform the processing unit(s) 702 and the overall computer architecture 700 from a general-purpose computing system into a special-purpose computing system customized to facilitate the functionality presented herein. The processing unit(s) 702 may be constructed from any number of transistors or other discrete circuit elements, which may individually or collectively assume any number of states. More specifically, the processing unit(s) 702 may operate as a finite-state machine, in response to executable instructions contained within the software modules disclosed herein. These computer-executable instructions may transform the processing unit(s) 702 by specifying how the processing unit(s) 702 transition between states, thereby transforming the transistors or other discrete hardware elements constituting the processing unit(s) 702.

The disclosure presented herein also encompasses the subject matter set forth in the following clauses.

Example Clause A, a method comprising: receiving a form with a plurality of typewritten text entries and a plurality of handwritten text entries; identifying a plurality of first locations on the form that respectively correspond to the plurality of typewritten text entries; identifying a plurality of second locations on the form that respectively correspond to the plurality of handwritten text entries; detecting a line on the form; identifying a group of text entries that have corresponding locations that are not separated by the line, wherein the group of text entries includes: a set of typewritten text entries of the plurality of typewritten text entries; and a set of handwritten text entries of the plurality of handwritten text entries; for each typewritten text entry in the set of typewritten text entries: determining a distance from a first location corresponding to the typewritten text entry to a second location corresponding to a handwritten text entry in the set of handwritten text entries; and determining an angle based on the first location corresponding to the typewritten text entry and the second location corresponding to the handwritten text entry; identifying a pairing solution for the set of typewritten text entries and the set of handwritten text entries using the distances and the angles determined for each typewritten text entry in the set of typewritten text entries; and outputting the pairing solution.

Example Clause B, the method of Example Clause A, further comprising generating a graph for the group of text entries, the graph including: first vertices corresponding to the typewritten text entries in the set of typewritten text entries; second vertices corresponding to the handwritten text entries in the set of handwritten text entries; and an edge between a first vertex, of the first vertices, and a second vertex, of the second vertices, wherein the edge is a vector that represents the distance and the angle determined for the typewritten text entry that corresponds to the first vertex.

Example Clause C, the method of Example Clause B, wherein the graph represents possible pairing solutions from which the pairing solution is identified.

Example Clause D, the method of any one of Example Clauses A through C, further comprising normalizing the distance determined for each typewritten text entry in the set of typewritten text entries based on a height and a width of an image that contains the form.

Example Clause E, the method of Example Clause D, wherein the pairing solution is identified using a pairing algorithm that minimizes a standard deviation of the normalized distances determined for the typewritten text entries in the set of typewritten text entries.

Example Clause F, the method of Example Clause D or Example Clause E, wherein the pairing solution is identified using a pairing algorithm that minimizes a sum of the normalized distances determined for the typewritten text entries in the set of typewritten text entries.

Example Clause G, the method of any one of Example Clauses A through F, further comprising using an unlikelihood scoring function to calculate scores for the angles determined for the typewritten text entries in the set of typewritten text entries, the unlikelihood scoring function established based on an assumption associated with a direction of writing for a language.

Example Clause H, the method of Example Clause G, wherein the pairing solution is identified using a pairing algorithm that minimizes a circular standard deviation of the scores calculated for the angles determined for the typewritten text entries in the set of typewritten text entries.

Example Clause I, the method of Example Clause G or Example Clause H, wherein the pairing solution is identified using a pairing algorithm that minimizes a sum of the scores calculated for the angles determined for the typewritten text entries in the set of typewritten text entries.

Example Clause J, the method of any one of Example Clauses A through I, further comprising using the structure to extract pairings from instances of the form.

Example Clause K, a system comprising: a processing system; and computer-readable storage media storing instructions that, when executed by the processing system, cause the system to: identify a plurality of first locations on a form that respectively correspond to a plurality of typewritten text entries; identify a plurality of second locations on the form that respectively correspond to a plurality of handwritten text entries; detect a line on the form; identify a group of text entries that have corresponding locations that are not separated by the line, wherein the group of text entries includes: a set of typewritten text entries of the plurality of typewritten text entries; and a set of handwritten text entries of the plurality of handwritten text entries; for each typewritten text entry in the set of typewritten text entries: determine a distance from a first location corresponding to the typewritten text entry to a second location corresponding to a handwritten text entry in the set of handwritten text entries; and determine an angle based on the first location corresponding to the typewritten text entry and the second location corresponding to the handwritten text entry; identify a pairing solution for the set of typewritten text entries and the set of handwritten text entries using the distances and the angles determined for each typewritten text entry in the set of typewritten text entries; and output the pairing solution.

Example Clause L, the system of Example Clause K, wherein the instructions further cause the system to generate a graph for the group of text entries, the graph including: first vertices corresponding to the typewritten text entries in the set of typewritten text entries; second vertices corresponding to the handwritten text entries in the set of handwritten text entries; and an edge between a first vertex, of the first vertices, and a second vertex, of the second vertices, wherein the edge is a vector that represents the distance and the angle determined for the typewritten text entry that corresponds to the first vertex.

Example Clause M, the system of Example Clause L, wherein the graph represents possible pairing solutions from which the pairing solution is identified.

Example Clause N, the system of any one of Example Clauses K through M, wherein the instructions further cause the system to normalize the distance determined for each typewritten text entry in the set of typewritten text entries based on a height and a width of an image that contains the form.

Example Clause O, the system of Example Clause N, wherein the pairing solution is identified using a pairing algorithm that minimizes a standard deviation of the normalized distances determined for the typewritten text entries in the set of typewritten text entries.

Example Clause P, the system of Example Clause N or Example Clause O, wherein the pairing solution is identified using a pairing algorithm that minimizes a sum of the normalized distances determined for the typewritten text entries in the set of typewritten text entries.

Example Clause Q, the system of any one of Example Clauses K through P, wherein the instructions further cause the system to use an unlikelihood scoring function to calculate scores for the angles determined for the typewritten text entries in the set of typewritten text entries, the unlikelihood scoring function established based on an assumption associated with a direction of writing for a language.

Example Clause R, the system of Example Clause Q, wherein the pairing solution is identified using a pairing algorithm that minimizes a circular standard deviation of the scores calculated for the angles determined for the typewritten text entries in the set of typewritten text entries.

Example Clause S, the system of Example Clause Q or Example Clause R, wherein the pairing solution is identified using a pairing algorithm that minimizes a sum of the scores calculated for the angles determined for the typewritten text entries in the set of typewritten text entries.

Example Clause T, computer-readable storage media storing instructions that, when executed by a processing system, cause a system to: identify a plurality of first locations on a form that respectively correspond to a plurality of typewritten text entries; identify a plurality of second locations on the form that respectively correspond to a plurality of handwritten text entries; detect a line on the form; identify a group of text entries that have corresponding locations that are not separated by the line, wherein the group of text entries includes: a set of typewritten text entries of the plurality of typewritten text entries; and a set of handwritten text entries of the plurality of handwritten text entries; for each typewritten text entry in the set of typewritten text entries: determine a distance from a first location corresponding to the typewritten text entry to a second location corresponding to a handwritten text entry in the set of handwritten text entries; and determine an angle based on the first location corresponding to the typewritten text entry and the second location corresponding to the handwritten text entry; identify a pairing solution for the set of typewritten text entries and the set of handwritten text entries using the distances and the angles determined for each typewritten text entry in the set of typewritten text entries; and output the pairing solution.

While certain example embodiments have been described, these embodiments have been presented by way of example only, and are not intended to limit the scope of the inventions disclosed herein. Thus, nothing in the foregoing description is intended to imply that any particular feature, characteristic, step, component, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element (e.g., two different text entries)

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method comprising:
receiving a form with a plurality of typewritten text entries and a plurality of handwritten text entries;
identifying a plurality of first locations on the form that respectively correspond to the plurality of typewritten text entries;
identifying a plurality of second locations on the form that respectively correspond to the plurality of handwritten text entries;
detecting a line on the form;
identifying a group of text entries that have corresponding locations that are not separated by the line, wherein the group of text entries includes:
a set of typewritten text entries of the plurality of typewritten text entries; and
a set of handwritten text entries of the plurality of handwritten text entries;
for each typewritten text entry in the set of typewritten text entries:
determining a distance from a first location corresponding to the typewritten text entry to a second location corresponding to a handwritten text entry in the set of handwritten text entries; and
determining an angle based on the first location corresponding to the typewritten text entry and the second location corresponding to the handwritten text entry;
identifying a pairing solution for the set of typewritten text entries and the set of handwritten text entries using the distances and the angles determined for each typewritten text entry in the set of typewritten text entries; and
outputting the pairing solution.

2. The method of claim 1, further comprising generating a graph for the group of text entries, the graph including:
first vertices corresponding to the typewritten text entries in the set of typewritten text entries;
second vertices corresponding to the handwritten text entries in the set of handwritten text entries; and
an edge between a first vertex, of the first vertices, and a second vertex, of the second vertices, wherein the edge is a vector that represents the distance and the angle determined for the typewritten text entry that corresponds to the first vertex.

3. The method of claim 2, wherein the graph represents possible pairing solutions from which the pairing solution is identified.

4. The method of claim 1, further comprising normalizing the distance determined for each typewritten text entry in the set of typewritten text entries based on a height and a width of an image that contains the form.

5. The method of claim 4, wherein the pairing solution is identified using a pairing algorithm that minimizes a standard deviation of the normalized distances determined for the typewritten text entries in the set of typewritten text entries.

6. The method of claim 4, wherein the pairing solution is identified using a pairing algorithm that minimizes a sum of the normalized distances determined for the typewritten text entries in the set of typewritten text entries.

7. The method of claim 1, further comprising using an unlikelihood scoring function to calculate scores for the angles determined for the typewritten text entries in the set of typewritten text entries, the unlikelihood scoring function established based on an assumption associated with a direction of writing for a language.

8. The method of claim 7, wherein the pairing solution is identified using a pairing algorithm that minimizes a circular standard deviation of the scores calculated for the angles determined for the typewritten text entries in the set of typewritten text entries.

9. The method of claim 7, wherein the pairing solution is identified using a pairing algorithm that minimizes a sum of the scores calculated for the angles determined for the typewritten text entries in the set of typewritten text entries.

10. The method of claim 1, further comprising using the structure to extract pairings from instances of the form.

11. A system comprising:
a processing system; and
computer-readable storage media storing instructions that, when executed by the processing system, cause the system to:
identify a plurality of first locations on a form that respectively correspond to a plurality of typewritten text entries;
identify a plurality of second locations on the form that respectively correspond to a plurality of handwritten text entries;
detect a line on the form;
identify a group of text entries that have corresponding locations that are not separated by the line, wherein the group of text entries includes:
a set of typewritten text entries of the plurality of typewritten text entries; and
a set of handwritten text entries of the plurality of handwritten text entries;
for each typewritten text entry in the set of typewritten text entries:
determine a distance from a first location corresponding to the typewritten text entry to a second location corresponding to a handwritten text entry in the set of handwritten text entries; and
determine an angle based on the first location corresponding to the typewritten text entry and the second location corresponding to the handwritten text entry;
identify a pairing solution for the set of typewritten text entries and the set of handwritten text entries using the distances and the angles determined for each typewritten text entry in the set of typewritten text entries; and
output the pairing solution.

12. The system of claim 11, wherein the instructions further cause the system to generate a graph for the group of text entries, the graph including:
first vertices corresponding to the typewritten text entries in the set of typewritten text entries;
second vertices corresponding to the handwritten text entries in the set of handwritten text entries; and
an edge between a first vertex, of the first vertices, and a second vertex, of the second vertices, wherein the edge is a vector that represents the distance and the angle determined for the typewritten text entry that corresponds to the first vertex.

13. The system of claim 12, wherein the graph represents possible pairing solutions from which the pairing solution is identified.

14. The system of claim 11, wherein the instructions further cause the system to normalize the distance determined for each typewritten text entry in the set of typewritten text entries based on a height and a width of an image that contains the form.

15. The system of claim 14, wherein the pairing solution is identified using a pairing algorithm that minimizes a standard deviation of the normalized distances determined for the typewritten text entries in the set of typewritten text entries.

16. The system of claim 14, wherein the pairing solution is identified using a pairing algorithm that minimizes a sum of the normalized distances determined for the typewritten text entries in the set of typewritten text entries.

17. The system of claim 11, wherein the instructions further cause the system to use an unlikelihood scoring function to calculate scores for the angles determined for the typewritten text entries in the set of typewritten text entries, the unlikelihood scoring function established based on an assumption associated with a direction of writing for a language.

18. The system of claim 17, wherein the pairing solution is identified using a pairing algorithm that minimizes a circular standard deviation of the scores calculated for the angles determined for the typewritten text entries in the set of typewritten text entries.

19. The system of claim 17, wherein the pairing solution is identified using a pairing algorithm that minimizes a sum of the scores calculated for the angles determined for the typewritten text entries in the set of typewritten text entries.

20. Computer-readable storage media storing instructions that, when executed by a processing system, cause a system to:
identify a plurality of first locations on a form that respectively correspond to a plurality of typewritten text entries;
identify a plurality of second locations on the form that respectively correspond to a plurality of handwritten text entries;
detect a line on the form;
identify a group of text entries that have corresponding locations that are not separated by the line, wherein the group of text entries includes:
a set of typewritten text entries of the plurality of typewritten text entries; and
a set of handwritten text entries of the plurality of handwritten text entries;
for each typewritten text entry in the set of typewritten text entries:
determine a distance from a first location corresponding to the typewritten text entry to a second location corresponding to a handwritten text entry in the set of handwritten text entries; and
determine an angle based on the first location corresponding to the typewritten text entry and the second location corresponding to the handwritten text entry;
identify a pairing solution for the set of typewritten text entries and the set of handwritten text entries using the distances and the angles determined for each typewritten text entry in the set of typewritten text entries; and
output the pairing solution.
